(19) United States
(12) Patent Application Publication
(10) Pub. No.: US 2002/0153685 A1
(43) Pub. Date: Oct. 24, 2002

(54) Slide plate for skateboards

(76) Inventors: Steven Russell Day, Cedar Rapids, IA (US); Michael Jon Ronnenberg, Cedar Rapids, IA (US)

Correspondence Address: WILLIAM C. RONNENBERG JR., APT. 603, 2950 VAN NESS STREET, WASHINGTON, DC, 20008, US

(21) Appl. No.: 09/839,190

(22) Filed: Apr. 19, 2001

(51) Int. Cl. B62M 1/00

(52) U.S. Cl. 280/87.042; 280/607

(57) ABSTRACT

A plate attached to the bottom surface of a skateboard deck to provide a consistent sliding surface when using the bottom surface of the deck to perform to perform tricks or acrobatic maneuvers. The plate mounts between the trucks of the skateboard and the deck and using the truck mounts and is designed to cover the bottom surface of the deck between the two trucks. The plate is cut to fit the prescribed area and is cut from hard plastic materials.

### BACKGROUND OF INVENTION

1. Field of Invention

This invention relates to skating devices and, in particular, to performance-enhancing devices used with or in conjunction with a skateboard.

2. Description of Related Art

A skateboard generally consists of a deck, trucks, and wheels. The skateboard and the sport of skateboarding have evolved to allow skateboarders to perform acrobatics and other tricks. The art of skateboarding has evolved on the streets and in skateboard parks which contain ramps and rails that emulate or improve acrobatic devices originally used in the streets and other urban environments. Many of the acrobatic devices used included curbs, handrails and other edges or surfaces that facilitated skateboarding maneuvers that require sliding or grinding the bottom of the skateboard across a rail, handrail, curb or other device with an appropriate edge or elevated surface. The sliding and grinding maneuvers inherently damage the bottom surface of a deck that most often contains a picture or graphic design. The damage caused to the bottom surface of the deck destroys the graphic design that is of personal valuable to the skateboarder as a symbol of status and personal preference. Additionally, the sliding and grinding maneuvers damage the bottom surface of the deck so as to provide an inconsistent surface for subsequent sliding and grinding maneuvers.

Devices have been developed to protect the bottom surface of the skateboard, but only the surface of the board between the trucks of the skateboard and the ends of the board. These devices include protective metal plates (U.S. Pat. No. 3,990,713) and protective wedges that are mounted under the kick-tails of later developed boards (U.S. Pat. No. 4,140,326). These devices were used to protect the bottom surface of the deck at the ends of the deck when the skateboarder performed maneuvers that required pivoting using the bottom rear and front edges of the deck. Additional devices have been attached to the bottom of the deck near the ends to act as frictional devices to facilitate braking or skidding (U.S. Pat. Nos. 4,199,165, 5,492,352). Other devices have been used to protect the bottom edges of the skateboard. These devices consist of rails or bumpers attached to the bottom edges of the deck along the ends and sides of the deck (U.S. Pat. Nos. 5,132,883, 4,182,520).

Other devices have been developed for use with modified skateboards or other skating devices. For example, skid pads of hard plastic have been employed to protect the bottom and facilitate sliding in a low profile skateboard design when riding over irregular terrain or surface debris (U.S. Pat. No. 5,267,743).

None of these devices, however, address the characteristics required of a skateboard deck when performing sliding or grinding maneuvers using the bottom surface of the deck in a skateboard park or urban environment. They provide surfaces that are either inconsistent or obtrusive when performing modern skateboard tricks or maneuvers. Many modern sliding and grinding tricks or maneuvers require sliding or grinding across a surface with the bottom surface, between the two trucks of a skateboard, in contact with the surface. In many of these maneuvers, sliding or grinding is performed with the bottom of the deck perpendicular to the longitudinal axis of surface. The characteristics required have been addressed by providing a special “slick” surface on the bottom of the deck, however, a slick surface is not durable and many skateboarders prefer a sliding or grinding surface more like a standard deck.

Therefore, what is needed is a skateboard having a deck with a durable, resilient bottom surface that maintains a consistent sliding or grinding surface.

### BRIEF SUMMARY OF THE INVENTION

The object of the present invention is to provide a durable, consistent sliding or grinding surface for the bottom surface of a skateboard deck.

Another object of the invention is to protect the graphic design on the bottom surface of a skateboard deck from being damaged.

Yet another object of the invention is to protect the integrity of the bottom surface of a skateboard deck.

The present invention is a durable, resilient plastic plate attached to the bottom surface of skateboard deck to provide a consistent, unobtrusive sliding or grinding surface. The sliding or grinding characteristics can be varied by using plastic having different characteristics. The sliding or grinding surface consists of a plastic plate that is attached to the bottom surface of a skateboard deck. The plate can also be mounted to the deck between the deck and trucks of the skateboard using the truck mounts. The plastic plate has holes near each end to allow the truck mounting screws to pass through the plate so the trucks can be mounted to the deck through the plastic plate attached to the deck. The holes can also be used to mount the plastic plate to the bottom surface of the skateboard deck. In which case, the plate is held firmly in position against the bottom surface of the deck when the trucks are mounted to the deck and can be easily replaced. In this manner the plate provides a consistent, resilient surface along the bottom of the skateboard deck, especially along the bottom surface of the deck between the trucks. Additionally, the integrity of the bottom surface of the deck and the graphic design on the bottom of the deck is protected. A plate constructed of clear or translucent plastic can be used to preserve the visibility of the graphic design on the bottom of the deck when the plastic plate is attached to the deck.

### BRIEF DESCRIPTION OF THE SEVERAL VIEWS OF THE DRAWINGS

FIG. 1 is a bottom perspective view of a skateboard with a slide plate.

FIG. 2 is a top view of a slide plate.

FIG. 3 is a side view of a skateboard with a slide plate.

### DETAILED DESCRIPTION OF THE INVENTION

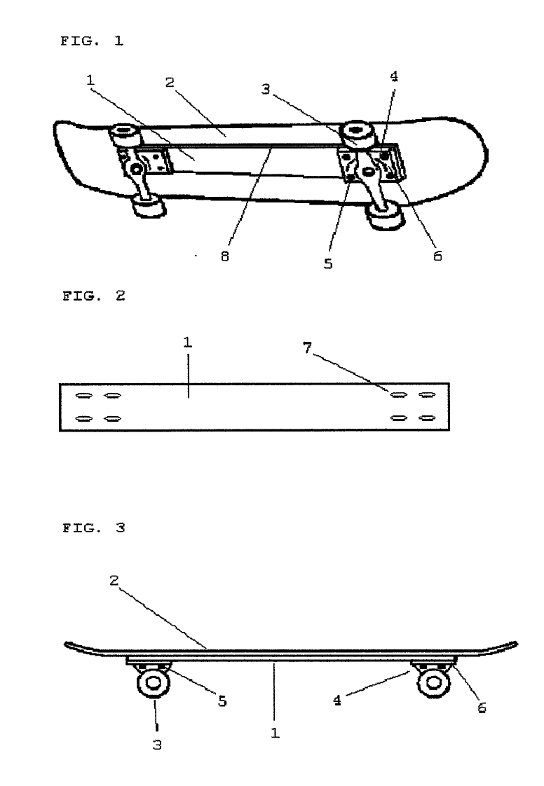

FIG. 1 shows a basic skateboard with a slide plate 1 attached to the bottom surface of the skateboard deck 2. A basic skateboard has a deck 2 and a pair of trucks 4 mounted to the bottom surface of the skateboard deck 2. Two wheels 3 are mounted to each truck. In the preferred embodiment of this invention, the slide plate 1 is mounted between the bottom surface of the deck 2 and the trucks 4. The slide plate is attached to the bottom surface of the deck 2 by pressure exerted on the slide plate 1 by the truck mounting bases 6 when mounted to the deck 2 by the truck mounting bolts 5. The slide plate 1 is held in position by the truck mounting bolts 5. With reference to FIG. 2, the mounting holes 7 of the slide plate 1 allow the truck mountings bolts 5 to pass through the slide plate 1 to facilitate the mounting of the slide plate 1 between the truck mounting bases 6 and the bottom surface of the deck 2.

In the preferred embodiment the end portions of the slide plate 1 located under the truck mounting bases 6 are of an appropriate dimension so that the end portions of the slide plate 1 mount flush with the outside edges of the truck mounting bases 6. FIGS. 1 and 3. Additionally, the width of the side plate 1 is equivalent to the width of the truck mounting bases 6 and of a length equivalent the distance between the outer margins of the truck mounting bases 6. FIG. 1. The exposed side edges 8 of the slide plate 1 between each of the truck mounting bases 6 can be beveled, shaped, or contoured to prevent the edge from biting during skateboard maneuvers.

The slide plate 1, shown in FIG. 2, can be constructed from resilient plastic materials including acrylic, modified acrylic, nylon, polycarbonate, polyester, polyethylene, polypropylene, polystyrene, polyurethane, and polyvinyl chloride. In the preferred embodiment, the slide plate is constructed from polycarbonate. The thickness of the slide plate can be varied between about 0.10 and about 0.33 inches, but in the preferred embodiment the slide plate is of one thickness preferably between 0.16 and 0.20 inches.

We claim:

1. A skateboard comprising:
an elongated deck having a bottom surface, a first end and a second end;
an elongated slide plate with a top surface, said top surface in contact with said bottom surface of said elongated deck assembly within the margins of said bottom surface of said elongated deck;
a first truck having a mounting base and a second truck having a mounting base said mounting base of said first truck mounted to said bottom surface of said elongated deck through said elongated slide plate near said first end of said elongated deck and said mounting base of said second truck mounted to said bottom surface of said elongated deck through said elongated slide plate near said second end of said elongated deck wherein said slide plate is mounted between said mounting bases of said first and said second truck assemblies and said bottom surface of said elongated deck; and
a first pair of wheels and a second pair of wheels said first pair of wheels mounted to said first truck assembly and said second pair of wheels mounted to said second truck assembly whereby said skateboard will roll lengthwise on a surface.

2. The skateboard of claim 1 wherein said elongated slide plate is constructed of resilient plastic materials selected from the group consisting of acrylic, modified acrylic, nylon, polycarbonate, polyester, polyethylene, polypropylene, polystyrene, polyurethane, and polyvinyl chloride.

3. The skateboard of claim 2 wherein said elongated slide plate is of a thickness between about 0.10 and about 0.33 inches.

4. The skateboard of claim 3 wherein said elongated slide plate further comprises a first end margin, a second end margin, and two side margins.

5. The skateboard of claim 4 wherein said elongated slide plate is of the same width as said mounting surfaces of said front and said second truck assemblies whereby said side margins of said elongated slide plate mount flush between said bottom surface of said elongated deck and said mounting surfaces of said first and said second truck assemblies.

6. The skateboard of claim 5 wherein the length of said slide plate is equivalent to the distance between the end-wise margin of said mounting base of said first truck assembly and the end-wise margin of said mounting base of said second truck assembly.

7. The skateboard of claim 6 wherein said two side margins of said elongated slide plate are beveled whereby said two side margins will not hang up, grab, or bite during a trick or maneuver.

8. A skateboard comprising:
an elongated deck with a bottom surface and an outer margin;
an elongated slide plate having an upper surface and lower surface located within said outer margin, said upper surface longitudinally in contact with said bottom surface of said elongated deck; and
two trucks, each truck having a mounting surface, each of said mounting surfaces attached to said bottom surface of said elongated deck through said elongated slide plate, each of said trucks having two wheels whereby the skateboard will roll lengthwise on four wheels.

9. The skateboard of claim 8 wherein the slide plate is of a width equivalent to the width of said mounting surfaces of each of said two trucks and of a length equivalent to the span between the distal margins of each of said mounting surfaces of said two trucks.

10. The skateboard of claim 9 wherein said elongated slide plate is constructed of resilient plastic materials selected from the group consisting of acrylic, modified acrylic, nylon, polycarbonate, polyester, polyethylene, polypropylene, polystyrene, polyurethane, and polyvinyl chloride.

11. The skateboard of claim 10 wherein said slide plate is of a thickness between about 0.10 and about 0.33 inches.

12. The skateboard of claim 11 wherein said slide plate further comprises two mounting ends and two exposed side edges, each of said two mounting ends located under each of said two mounting surfaces of said two trucks, each of the two exposed side edges located exterior to each of said mounting surfaces of said two trucks between each of said two trucks.

13. The skateboard of claim 12 wherein said exposed side edges of said elongated slide plate are beveled whereby said exposed side edges will not hang up, grab, or bite during a trick or maneuver.

14. A slide plate for a skateboard comprising:
an elongated plate with a first end and a second end; and
a plurality of mounting holes through said first and second ends of said elongated plate whereby said elongated plate can be mounted between the bottom surface of a skateboard deck and the truck mounting bases by the truck mounting bolts.

15. The slide plate of claim 14 wherein said elongated slide plate is of a width equivalent to the width of the truck mounting surfaces and of a length equivalent to the span between the end margins of each of the truck mounting surfaces.

16. The slide plate of claim 15 wherein said elongated slide plate is constructed of resilient plastic materials selected from the group consisting of acrylic, modified acrylic, nylon, polycarbonate, polyester, polyethylene, polypropylene, polystyrene, polyurethane, and polyvinyl chloride.

17. The slide plate of claim 16 wherein said elongated slide plate is of a thickness between about 0.10 and about 0.33 inches.

18. The slide plate of claim 17 wherein said elongated slide plate is about 0.25 inches thick.
